(19) United States
(12) Patent Application Publication
(10) Pub. No.: US 2006/0243804 A1
(43) Pub. Date: Nov. 2, 2006

(54) Container comprising code information elements

(75) Inventors: Lasse Wengel Christoffersen, Soborg (DK); Preben Mikael Nielsen, Holbaek (DK); Lennart Bo Erik Berggren, Lund (SE)

Correspondence Address: NOVO NORDISK, INC.;PATENT DEPARTMENT, 100 COLLEGE ROAD WEST, PRINCETON, NJ, 08540, US

(73) Assignee: Novo Nordisk A/S, Bagsvaerd (DK)

(21) Appl. No.: 11/396,889

(22) Filed: Apr. 3, 2006

Related U.S. Application Data
(63) Continuation of application No. PCT/DK04/00662, filed on Sep. 30, 2004.

(30) Foreign Application Priority Data
Oct. 3, 2003 (DK) PA 2003 01457
Oct. 23, 2003 (DK) PA 2003 01560

(51) Int. Cl. G06K 7/10; G06K 19/00

(52) U.S. Cl. 235/454; 235/487

(57) ABSTRACT

This invention relates to a container (10) for a medication delivery (110) device comprising an optical reader (111), where said container comprises a code information element (20) carrying a set of information readable by said optical reader where the container comprises at least one more code information element (20) carrying the set of information readable by said optical reader. The invention further relates to a method of applying code information elements onto the container and to a method of reading a code information element. The code information elements can be aligned with at least one protrusion on the container, or are aligned with at least one cavity on the container. Alternatively or additionally, the code information elements are juxtaposed to one another. Hereby, an optical code reader, embedded in the medication delivery device, will be able securely to read the information carried by means of image processing software compiling and combining more code information elements. With more code information elements available, it is possible to re-create a perfect image from several code information elements applied on the container. Thus, the undesirable effects, arising from humidity, dirt, dirty or sweaty fingers damaging the code information elements are minimised.

This invention relates to a container for a medication delivery device comprising an optical reader, where said container comprises a code information element carrying a set of information readable by said optical reader.

This invention further relates to a method of applying code information elements onto the container.

Additionally, the invention relates to a method of reading a code information element.

In applications of medication delivery devices for treatment of a disease, e.g. diabetes, containers with medication for a certain number of doses are mounted in the delivery device, e.g. a pump, a syringe, a pen injector, etc and exchanged with a new one when the container is empty, is obsolete or when another medication is to be used according to the particular situation. It is of paramount importance that the medication used is the intended one, that it is not too old, that it has the correct concentration, type etc. Therefore the marking of the container with the medication has to be given special attention. To aid the user in achieving a satisfactory level of security in the use of a medication delivery device, a marking of the container in addition to a traditional alphanumeric inscription has been introduced. Apart from information on the contents of the container, the item of information may hold technical data on the type of container, outlet dimension or other information of relevance to the medication delivery process.

It is anticipated that drug administration devices, dosage apparatuses, syringes, pumps, inhalation devices will be provided with means for Blood Glucose Monitoring or Continuous Blood Glucose Monitoring, etc, these devices, typical in the future will be provided with computing power. The computing power could then be used to read and interpret the set of information on the container which comprises amounts of reliable data. These devices will then be able to check whether that the drug from the container can be supplied, e.g. injected in a proper dose and in a proper concentration before exceeding expiry date, from an approved predefined known supplier of the content.

A user of containers may—for various medication purposes—have a set of geometrical alike containers, i.e. containers all having the same shape. However these containers may comprise different medicine in various formulations, i.e. constitute a product safety problem for the user since chances of choosing a wrong container are rather high. As an example, insulin it is known to be supplied in different concentrations for various purposes, such as slow acting, fast acting, mix insulin. It is therefore of great importance for the patient to select and apply only the right container for his treatment, if wrong content applied, it can cause severe problems, e.g. hyper or hypoglycaemia.

A readable code applied on said containers is therefore helpful in distinguishing such containers from one another, e.g. the readable code may be read from a reader inside a medication delivery device in order to select and subsequently only to apply medicine from the container having the correct content.

It is known in the art to have one single barcode label mounted on Penfill for the primary purposes of handling manufacturing logistics.

It is further known to use said Penfill® as an insertable and removable medical container into a syringe, such as pen injectors known from Novo Nordisk.

Often containers with medication are to be stored in a cool environment, e.g. in a fridge prior to use.

However, humidity from bringing the container in an out from the fridge will have the effect that the container condensates, which may unwillingly deteriorate the coded information on the container. The coded information, e.g. the barcode or matrix coded label, or any other printed label on the container, i.e. the labels carrying the coded information may then end up being non readable.

The same applies for wear on the label's coded information when handling either during the manufacturing process, at the point of sale or during the end user's handling or preparations prior to use of the medication or the drug in the container.

Correspondingly, dirt, dirty or sweaty fingers touching the container's coded information on the container may also deteriorate the coded information again rendering the coded information non-readable

This, of course is very problematic, since such various harmful effects to coded information on the container may, in the end, render the originally readable coded information printed on the label of the container unreadable. This, as a consequence—when the container is used in devices, such as pumps or syringes capable of reading the information printed, e.g. prior to dose setting and injection—also renders the container unusable in such devices and as a stand alone product as well.

Thus, an object of the present invention is to provide a container with readable information, such as medicament type, expiry date, which improves the likelihood that the information printed on the container can be read with a high degree of security from a reader within a medication delivery device.

The object is achieved according to the invention in that the container comprises at least one more code information element carrying the set of information readable by said optical reader.

Hereby it is rather likely that an optical code reader—embedded in the medication delivery device—attempting to read more than one code information element will be able to read the information carried, i.e. said set of information. E.g. sophisticated image processing software can compile and combine picture elements from more partly damaged code information elements, i.e. compiling and combining only picture elements undamaged, such that one single complete undamaged picture element is re-created as an image through sampling of undamaged image parts, i.e. undamaged parts of code information elements. The more code information elements available—even though more or all of these are partly damaged—the more likely it is that it is possible to re-create one single complete picture element—as the perfect image—from several code information elements applied on the container. Thus, the undesirable effects, arising from humidity, dirt, dirty or sweaty fingers damaging the code information elements are minimised.

Since the container carrying the coded information is to be read from or within an optical reader embedded in the medication delivery device, such as a syringe, a pump, it is a further object of the invention that the container's coded information can be securely and easily read when the container applied, i.e. the container is positioned and fixed into said medication delivery device prior to use.

In other words, it is a further object of the invention to provide a solution by using coded information on the container, where it is not necessary to provide specialized means for locating said coded information on the applied container in relation to the medication delivery device that is to be able to read the coded information.

The further object is achieved when code information elements are aligned with at least one protrusion, e.g. a tooth—or are aligned with at least one cavity on the container.

E.g. a cavity or more cavities present on the cartridge may match contacting surfaces, e.g. a protrusion or more protrusions present in the medical delivery device. Thus, the code information elements are brought in round going alignment with one or more of the protrusions of the medical delivery device. Consequently, the optical code reader can in this embodiment be brought in alignment with one or more of the code information elements.

Alternatively, a protrusion or more protrusions present on the cartridge may match contacting surfaces, e.g. a cavity or more cavities present in the medical delivery device. Thus, the code information elements are brought in round going alignment with one or more of the cavities of the medical delivery device. Consequently, the optical code reader can in this embodiment also be brought in alignment with one or more of the code information elements.

Thus, in both cases, the optical code reader will know where the coded information, i.e. the code information elements, are applied on the container.

Said further object is also achieved when code information elements are juxtaposed to one another.

As an example, when several code information elements are juxtaposed to one another neither a cavity nor a protrusion is necessary for alignment of the cartridge, when the cartridge is placed into the medical delivery device. The optical code reader will then be able to read one or more code information elements when the cartridge is properly positioned towards the reader, i.e. the optical code reader will “see” one or more of the coded information elements on the cartridge.

In an exemplary embodiment of the invention, when code information elements are juxtaposed to one another and all the way around the cartridge, thus the optical code reader will then be able to read one or more code information elements, since these will always be present for the reader regardless of the orientation of the cartridge. Consequently, the optical code reader will “see” one or more of the coded information elements on the cartridge independent of its round-going orientation in the medical delivery device code.

In the present context, the term ‘container’ is taken to mean a container for holding a liquid, or a powder or combinations thereof or other matter of size, volume and weight, e.g. a drug or a medicament. The container may contain medication for use with a medication delivery device or system, e.g. a syringe or a pump, for treatment or self-treatment of a disease. The medication in the container may e.g. be insulin for use with a pen-type injection system for treating diabetes. Furthermore, the container may, as exemplary embodiments, be a bottle, a bag, a cartridge, a vial or a pre-filled syringe, a blister pack, all of which are capable of containing medication in some form.

The invention will be explained more fully below in connection with preferred embodiments and with reference to the drawings, in which:

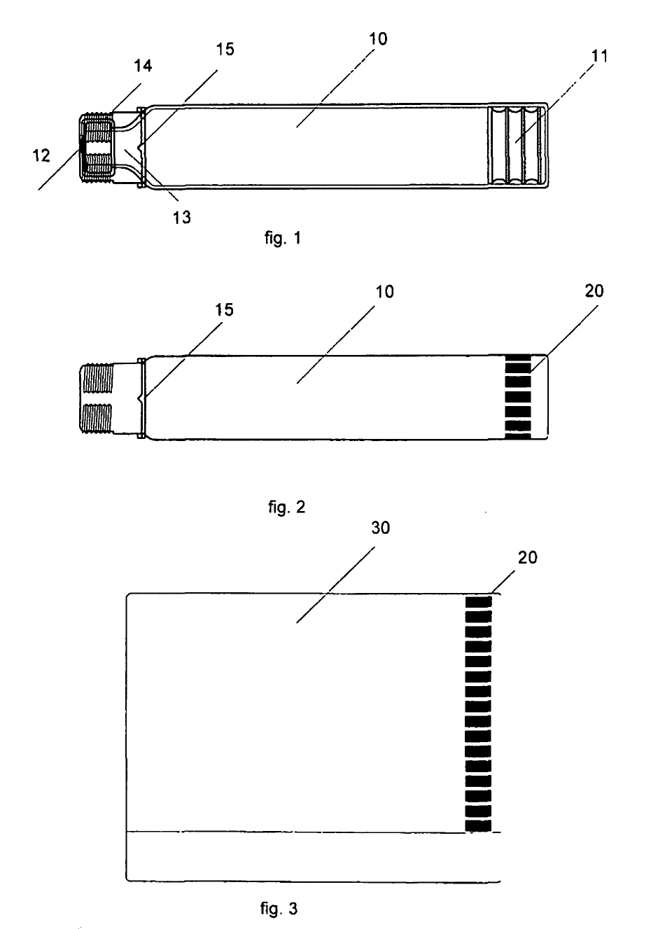

FIG. 1 shows an unlabelled cartridge product;

FIG. 2 shows repeated code information elements applied on the cartridge;

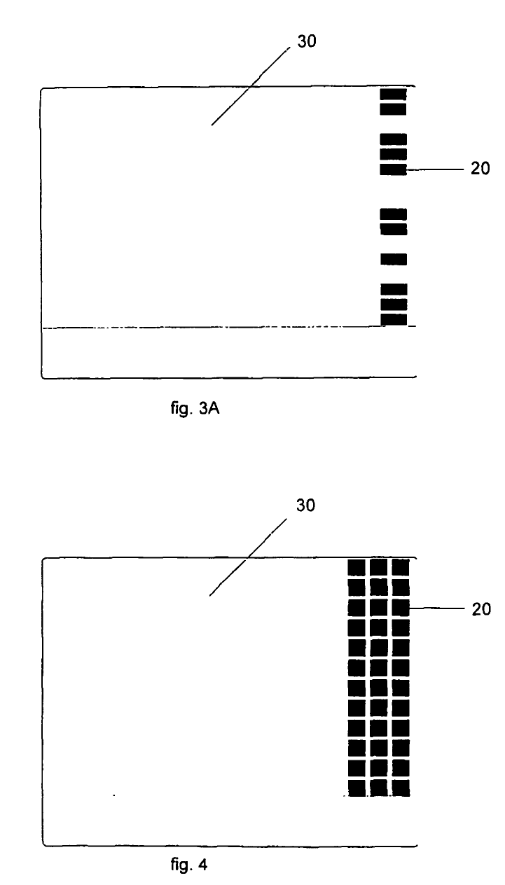

FIG. 3 shows a label with repeated code information elements;

FIG. 3A also shows another label with repeated code information elements;

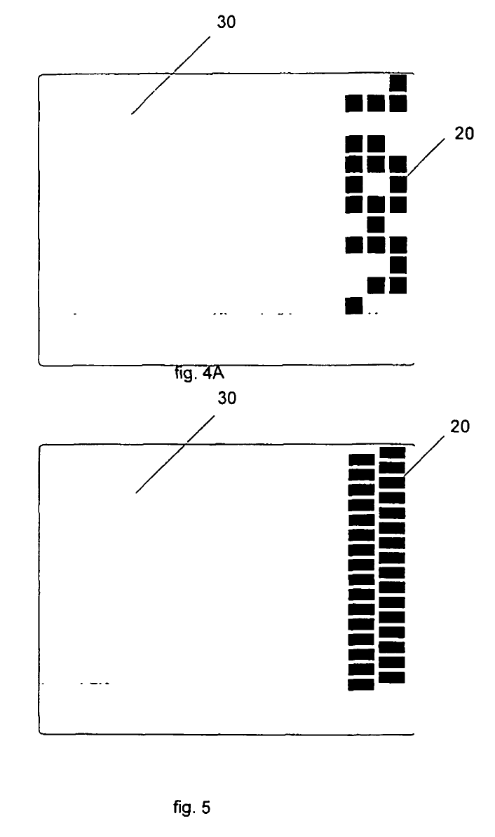

FIG. 4 shows a label with code information elements that are repeated in axial and round going direction;

FIG. 4A shows another label with code information elements that are repeated in axial and round going direction;

FIG. 5 shows a label with mutually axially displaced code information elements;

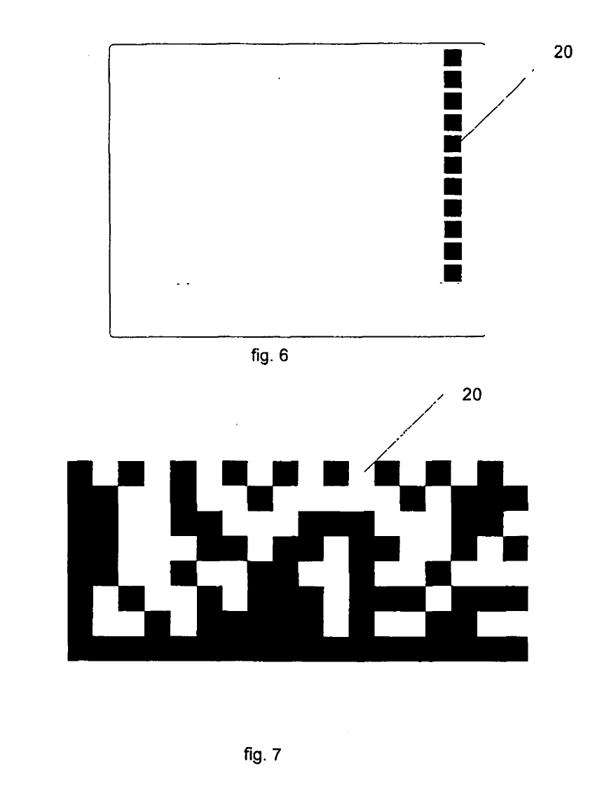

FIG. 6 shows quadratic repeated code information elements;

FIG. 7 shows an exemplary code information element;

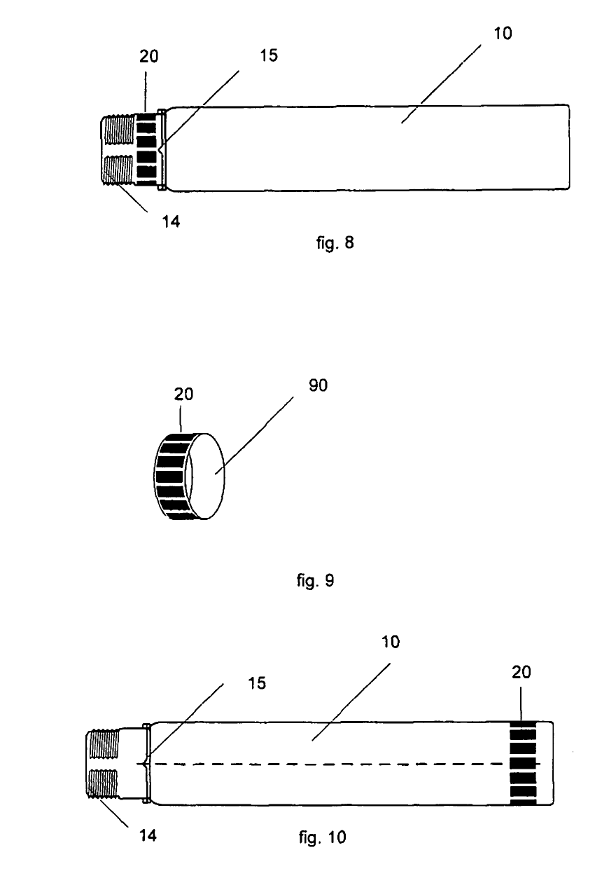

FIG. 8 shows a cartridge where the repeated code information elements are applied on its code top;

FIG. 9 shows a repeated code information element applied on an endless band.

FIG. 10 shows a protrusion at the code top.

FIG. 11 shows a cartridge inside a drug administration device.

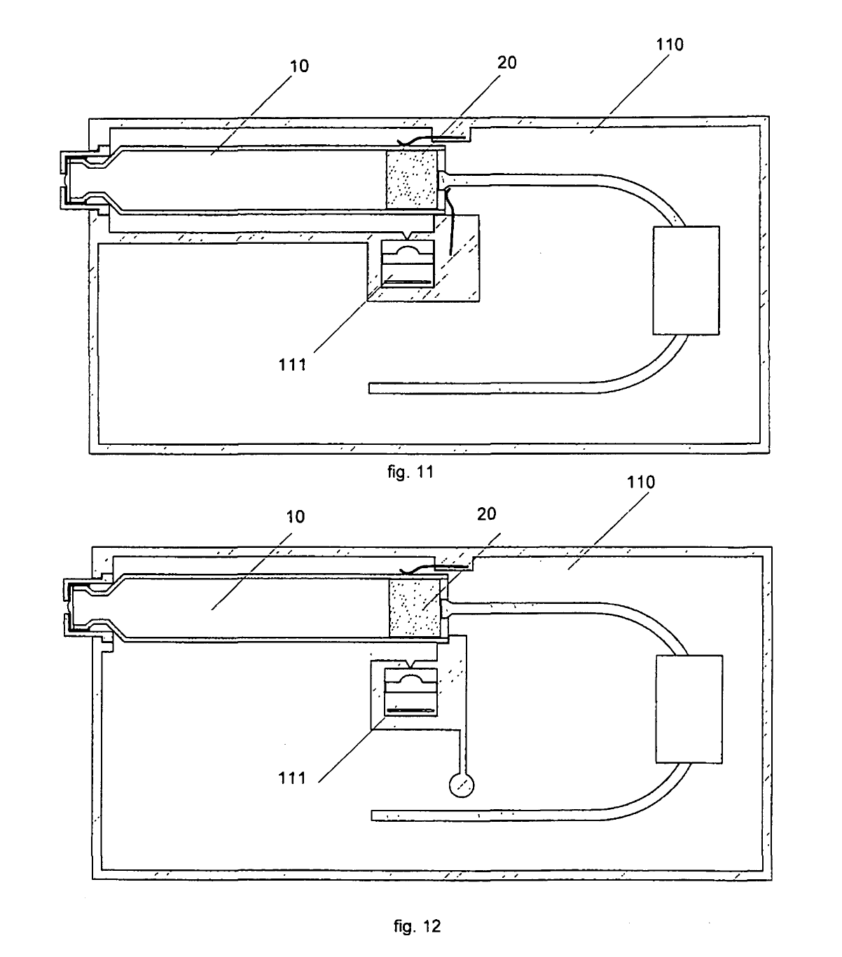

FIG. 12 shows another cartridge inside another drug administration device.

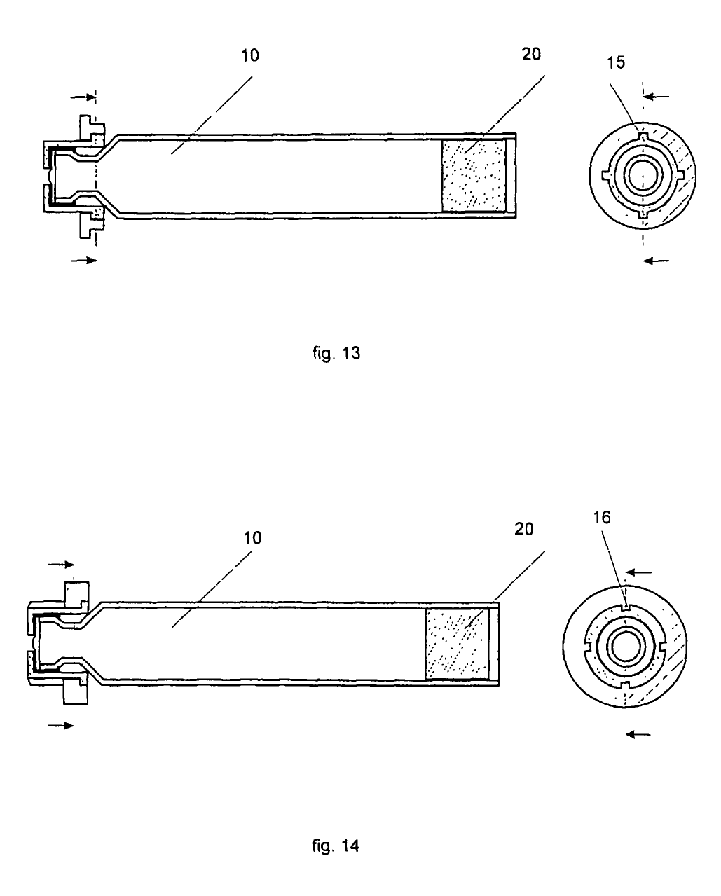

FIG. 13 shows protrusions on the cartridge;

FIG. 14 shows cavaties on the cartridge; and

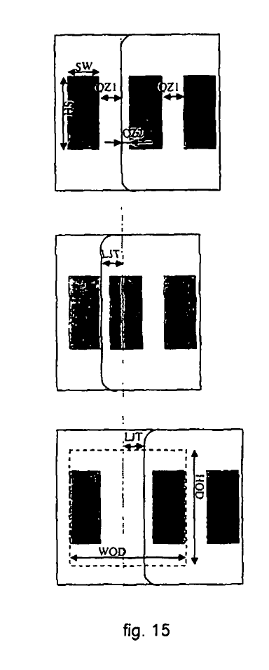

FIG. 15 shows requirements to a band of code information elements.

Throughout the drawings, the same reference numerals indicate similar or corresponding features, functions, elements, etc.

FIG. 1 shows an unlabelled cartridge product, it comprises a glass cartridge, a plunger, a septum, a cap and a threaded code top. The Figure shows the unlabelled cartridge product of reference numeral 10. This is applicable in a medical delivery device, e.g. for pen injectors that contains the glass cartridge (10) with a medicament, the plunger (11), the septum (12), the cap (13) and the threaded code top (14). The cartridge product may have one or more protrusions (15), e.g. a tooth or teeth for mechanical coding for alignment of the container in a device capable of reading one or more code information elements, i.e. said teeth or tooth can be suitable for aligning the cartridge product in a medical delivery device, e.g. in a pump, in a syringe. Moreover, such an alignment will improve the accuracy toward an optical reader integrated in the medical delivery device when the cartridge product—as shown in the next figures—comprises one or more code information elements. As an alternative to said teeth or tooth, one or more cavities may as well be suitable for aligning the cartridge product in the delivery device, and consequently also suitable for aligning the cartridge product towards said optical reader, whereby—in both cases—the optical reader can easily and more securely read one or more code information element(s)—or parts of them—positioned relative to said teeth, tooth or cavities, since the optical reader—due to said accurately positioned code information elements on a fixed container knows from which point(s) it has to capture images (represented in one or more code information elements).

In other words, the cavity—as shown on FIG. 14 by means of reference numeral 16—may in principle provide the same functionality as said protrusion, as shown on FIG. 13 by means of reference numeral 15. For the latter case, in general, it is hereby possible that one or more code information elements are aligned with at least one protrusion, e.g. aligned to a tooth or teeth on the container. Likewise, it is therefore possible that one or more code information elements are aligned with at least one cavity on the container. In all cases, these (protrusion, cavity) enable easily reading of coded information on the container, since these provided means (cavity, protrusion) may be used for locating code information element(s) in the medication delivery device. The optical reader embedded in the medication delivery device is then able to read the coded information, since the position of code information element(s) is fixed relatively to one or more cavities or protrusions on the container, when fixed in the medication delivery device. In the medication delivery device a protrusion may fit into a cavity on the container, and—vice versa—in the medication delivery device a cavity may fit into a protrusion on the container, thereby—in both cases—accurately fixing the position of one or more code information elements—on the container—towards the optical reader embedded in the medication delivery device.

FIG. 2 shows repeated code information elements applied on the cartridge in accordance with the invention. A code information element is repeated around the cartridge. The repeated code information elements are applied opposite to the plunger in its storage position.

When repeated code information elements are applied on the cartridge, it is rather likely that an optical code reader attempting to read more than one code information element will be able to read the information carried. E.g. sophisticated image processing software can compile and combine picture elements from more damaged code information elements, i.e. compiling and combing only picture elements undamaged, such that one single complete undamaged picture element is re-created as an image through sampling of undamaged image parts. The more code information elements available—even though more or all of these are partly damaged—the more likely it is of course that it is possible to re-create one single complete picture element—as the perfect image—from more code information element applied on the container.

In an embodiment of the invention, at least two code information elements are juxtaposed to one another. It will then be possible for an optical reader embedded in the medication delivery device to image process these elements, and—again—it is likely to combine picture elements from, in this case two eventually partly code information elements, in order to re-created an undamaged image.

In another embodiment of the invention, several code information elements are juxtaposed to one another around the cartridge, and—again—it will be possible to re-create an undamaged image from several juxtaposed code information elements, if needed.

Of course, if none of said code information element is damaged, a single one of these may be optically read. However, during image processing it is also possible to combine parts from two ore more undamaged code information elements in order to extract the information, since the same set of information is carried in each of said code information elements. This could be the case if the optical reader is not accurately positioned exactly towards one single code information element, but when it is more in position to capture two or more code information elements prior to image processing.

In still another embodiment of the invention, even more code information elements can be juxtaposed to one another. As an example, juxtaposed to one another all the way around the cartridge, and in this embodiment, it will to an even higher degree be possible to recreate an undamaged image from these many juxtaposed code information elements.

This embodiment is advantageous, since the cartridge can be positioned into the drug administration device (110)—see FIGS. 11 and 12—without the need to take advantage of any cavity or protrusion on the code top. This is the case, since the cartridge is provided with these many juxtaposed code information elements all the way around the cartridge. The optical reader—se FIGS. 11 and 12, reference numeral 111—will always have one or more code information elements presented to it when the cartridge is positioned into the drug administration device, this is the case regardless of the round-going orientation of cartridge in this embodiment.

In the above mentioned embodiments, the coded information, from one or more code information elements, can be securely and easily read (by the optical reader) when the cartridge is positioned in various ways into said drug administration device.

The distance between juxtaposed code information elements repeated around the cartridge may be dependent on the tolerance of the diameter of the cartridge. This is to ensure that code information elements being juxtaposed across a label are not overlapping each other due to cartridge circumpherence uncertainty.

The cartridge may comprise a plunger and one ore more code information elements may be applied directly opposite the plunger in its position of storage. This is an advantage, since it provides unhindered visual inspection of cartridge content.

The axial position of the code information elements may be defined relative to the end of the cartridge comprising the plunger in its position of storage, this is an advantage since it may minimize the field of vision required for the optical reader in both axial directions of the optical reader.

FIG. 3 shows a label with repeated codes that can be wrapped around the cartridge. The label contains a predominantly transparent part that allows visual inspection of the cartridge content. The label height is larger than the cartridge circumference and therefore a lower portion of the label will be covered by an upper portion of the label.

FIG. 3A also shows a label with repeated code information elements, however with another pattern than that of the foregoing figure. Said label can also be wrapped around the cartridge. The label contains a predominantly transparent part that allows visual inspection of the cartridge content. The label height is larger than the cartridge circumference and therefore a lower portion of the label will be covered by an upper portion of the label.

FIG. 4 shows a label with code information elements that are repeated in axial and round going direction.

FIG. 4A shows a label with code information elements that are repeated in axial and round going direction.

From FIGS. 4 and 4A, it is apparent that even more than two code information elements may be applied on the container from said label. Hereby it is rather likely, that the optical code reader—embedded in the medication delivery device—attempting to read more than one code information element will be able to read the information carried.

It is also apparent from FIGS. 4 and 4A, showing labels with code information elements, that when one of these labels is applied on the container—code information elements can be repeated a number of times along the container.

As discussed, a task may be to apply a label to the container; this can be automated in the following way:

Code information elements may in before have been applied on an endless band. The endless band is arranged to be pushed over the container, and from that a part or parts of said endless band then are applied onto the container.

FIG. 5 shows a label where mutually axially displaced code information elements are also mutually repeated by half the repetition distance around the cartridge.

The figure shows that at least two code information elements can be juxtaposed to one another. As previously discussed, code information elements can be juxtaposed to one another all the way around the cartridge, and in this embodiment, it will to a high degree be possible to recreate an undamaged image from these many juxtaposed code information elements.

It is apparent from FIG. 5 that said code information elements may be mutually axially displaced.

It is also apparent from FIG. 5, that said mutually axially displaced code information elements can be mutually rotated.

In an exemplary embodiment of the invention, said rotation corresponds to half the repetition distance around the container.

In still another embodiment of the invention, 1-100 further code information elements are applied on the container—eventually be means of one ore more labels carrying them, thus to a high degree of certainty an undamaged image can be created.

In still another embodiment of the invention, 2-20 further code information elements are applied on the container—eventually also by means of even more labels carrying them, thus to a high degree of certainty an undamaged image can be created.

In still another embodiment of the invention, 3-30 further code information elements are applied on the container—by means of several labels carrying them, thus again to a high degree of certainty an undamaged image can be created.

The purpose of said label—where discussed and shown in the foregoing drawings—is that it can be wrapped around the container. This enables for an easy, secure “printing” of code information elements onto the container.

The label with code information elements may be applied on the surface of the container, e.g. on the outer surface of it, in that case the code information element are printed on the label.

Alternatively, code information elements may be applied directly on any of the surfaces of the container, preferable on the outer surface of it to enhance readability.

Information in each of the code information elements may be laser engraved to resist wear.

In an embodiment of the invention, said label may integral with another label for carrying readable information, i.e. for carrying code information elements.

The said another label may be transparent to ease visibility to the medicament in the container.

FIG. 6 shows quadratic repeated code information elements (20).

FIG. 7 shows an exemplary code information element.

As can be seen, a code information element may comprise pixels.

The code information element shown here comprises a Data Matrix code. This is known to comprise redundant data, thus it enables a subsequent error correction, e.g. by use of error correction algorithms.

The data, i.e. the set of information in code information element may represent at least a medicament type, further it may represent an expiry date, and or a batch number.

Additionally, the set of information may also comprise a string of characters representing a manufacturer of the container's content, e.g. Novo Nordisk, an affiliate company, etc.

Additionally, the set of information may also comprise a string of characters representing a manufacturer of the container.

Hereby, an optical reader of the drug administration device can read the image representing the set of information on the container, and subsequently the set of information on the container can be decoded and interpreted. The device can then check whether the drug, i.e. the read medicament type, is allowed to be supplied, i.e. injected in a proper dose and in a proper concentration from the read manufacturer, provided that the read expiry date is not exceed.

Said batch number may be used for tracing sold products, for quality control, etc, it may even be used for withdrawal of products, e.g. withdrawals of sold containers bearing a specific batch number series.

Since code information elements are to be read, it is advantageous that a surface of an information-carrying area of each of said code information elements is treated to enhance optical reading.

The treatment thereby enhances reading of said set of information.

The treatment may comprise use of a transparent printing ink with dispersed transparent particles.

The size of each of said particles may as—an exemplary embodiment—be approximately 5-10 times smaller than a size of pixels in each of the code information elements.

FIG. 8 shows a cartridge where the repeated code information elements are applied onto the code top. It can be seen that a tooth (15) at the code top (14) can be used to align one or more the repeated code information elements against an optical reader.

Even though more protrusions are shown, one single protrusion, e.g. a tooth on the container may be used to align code information elements when applied on the container.

Correspondingly, even though more cavities are shown, one single cavity may be used to align code information elements on the container.

FIG. 9 shows a repeated code information element applied on an endless band that can be arranged to be pushed over a container.

FIG. 10 shows a protrusion, e.g. teeth (15) at the code top (14)—which as discussed in the foregoing figures may be used to align one ore more repeated code information elements. In this figure the repeated code information are aligned to a tooth (15)—e.g. at the code top (14) as shown in FIG. 8—or as shown in the figure to align code information elements on the surface anywhere on the container.

Correspondingly, a cavity (16) at the code top as shown in FIG. 14, may be used as a fix point, i.e. the cavity may be used to align code information elements, e.g. at the code top (14) as shown in FIG. 8.

FIG. 11 shows a cartridge inside a medical delivery device (110). An optical code reader (111) placed inside the device enables reading of the code information elements. The optical code reader comprises an image sensor, a lens, an aperture and a contacting surface. One or more protrusions present at the cartridge match contacting surfaces in the medical delivery device. Springs in the device facilitate that the corresponding medical device and cartridge contacting surfaces meet. The contacting surfaces enable alignment of the code information elements and the optical code reader along the axial and radial direction of the cartridge cylinder. Furthermore, if the code information elements are brought in round-going alignment with one or more of the protrusions, then the optical code reader can be brought in round going alignment with the code information elements.

E.g. a cavity or more cavities present on the cartridge may match contacting surfaces, e.g. a protrusion or more protrusions present in the medical delivery device. Thus, the code information elements are brought in round going alignment with one or more of the protrusions of the medical delivery device. Consequently, the optical code reader can in this embodiment be brought in alignment with one or more of the code information elements.

Alternatively, a protrusion or more protrusions present on the cartridge may match contacting surfaces, e.g. a cavity or more cavities present in the medical delivery device. Thus, the code information elements are brought in round going alignment with one or more of the cavities of the medical delivery device. Consequently, the optical code reader can in this embodiment also be brought in alignment with one or more of the code information elements.

Thus, in both cases, the optical code reader will know where the coded information is applied on the container.

In an exemplary embodiment of the invention, when code information elements are juxtaposed to one another and all the way around the cartridge, e.g. the cartridge as shown in FIG. 8, neither a cavity nor a protrusion is necessary for alignment of this cartridge, when placed into the shown medical delivery device. The optical code reader (111) will be able to read one or more code information elements, since it or these will be present for the reader regardless of the orientation of the cartridge. Consequently, one or more of the coded information elements will be imaged on the optical code reader independent of the cartridge's round-going orientation in the medical delivery device code

Thus, in this case it is an advantage that there is no special requirement for a round-going orientation of the container in the medical delivery device.

Thus in the above mentioned embodiments, the optical reader of use may have a field of vision that is so comprehensive that it is able to accommodate significantly more than one single code information element.

Correspondingly, an image sensor may be used together with optics for presenting one single code information element and at least one fraction of a neighbouring code information element on the optical reader.

FIG. 12 is another embodiment of another medical delivery device (110) where a contacting surface at the optical code reader meets the cartridge base. The optical code reader is associated to the device shell by means of a flexible beam that acts as a spring that forces the optical code reader towards the cartridge base in the axial direction.

FIG. 13 shows protrusions (15) on the cartridge as well as the part of the device shell that is brought in contact with the cartridge. Cross sections along axial and radial axes are shown.

FIG. 14 shows cavities (16) in the cartridge as well as the part of the device shell that is brought in contact with the cartridge.

FIG. 15 shows requirements to a band of code information elements.

The geometry of the band of code information elements is considered. The band geometry must ensure that at least one whole code information element symbol is imaged regardless of the rotation along the cylinder axis of the cartridge. Also, at least one whole code information element symbol must be imaged when the overall tolerances of the system are taken into consideration. Important quantities are defined in the table. The quantities LJT and QZ2 are defined in FIG. 15.

| Quantity | Remark | Given values |
|---|---|---|
| QZ1 | Quit zone 1 | |
| QZ2 | Quit zone 2 | |
| SW | Symbol width | |
| SH | Symbol height | |
| LJT | Label joint tolerance | π * 0.15 mm = 0.47 mm |
| LXT | Label x tolerance | 0.5 mm |
| WOD | Width of object to be depicted | |
| HOD | Height of object to be depicted | |
| N | Number of symbol on band | |
| Nmax | Calculated maximum of N | |
| C | Cartridge circumference | π * 11.15 mm = 35.03 mm |

From the illustrations, the following relations between label joint tolerance (LJT), quit zones (QZ1 and QZ2), symbol width (SW) and width of object (WOD) to be depicted are obtained.
LJT≦QZ1 (See central illustration at FIG. 15)
WOD≧2*SW+QZ1+QZ2+LJT (See lower illustration at FIG. 15)

The circumference of the cartridge (C) is related to the number of symbols (N) (=number of code information elements) in the following way
C=N*(SW+QZ1)+QZ2

Now the maximum number of symbols (Nmax) is sought by using the relation between LJT and QZ1
C≧Nmax*(SW+LJT)+QZ2

That is
Nmax=(C−QZ2)DIV(SW+LJT)
QZ1=(C−QZ2)/N−SW (Then WOD can be calculated)

It can be chosen to make N equal to Nmax to minimise WOD, or to decrease N and thereby increase QZ1 and decrease the risk of label joint failures. The height of object to be depicted is related to the symbol height and label x-tolerance by
HOD≧SH+2*LXT

One exemplary embodiment of design is shown below:
SW=0.2*8 mm=1.6 mm
SH=0.2*18 mm=3.6 mm
C=35.03 mm
LTJ=QZ2=LXT=0.5 mm
N=Nmax=(35.03−0.5)DIV(1.6+0.5)=16
QZ1=(35.03−0.5)/16−1.6=0.56 mm
WOD≧4.76 mm
HOD≧(3.6+2*0.5) mm=4.6 mm

In an exemplary embodiment of the invention, the distance between juxtaposed code information elements repeated around the container is therefore dependent on the tolerance of the diameter of the container as discussed above. This enables for that a number of code information elements, (N) can be computed to a predetermined number and also to a predetermined distance between two juxtaposed code information elements as shown in the formulas above. The predetermined distance the applied between every two juxtaposed code information elements.

In the following a discussion is given with respect to how the optical reader with surrounding elements may be implemented, how to sample an image and how this is related to the label's design:

In order to capture the image from the cartridge a CMOS sensor may be the choice of use. The CMOS sensor has the advantage compared to CCD sensors of being small and cheap, and since it has a low power consumption. Furthermore, it is easy to use and do not require use of external components like clock and analogue to digital converters.

Because the label on the cartridge need only be black and white, the image sensor does not have to be a colour image sensor.

The area of the captured image, which is of interest, may be twice the size of the DM plus 2 times the area between two DM. That the criterion is a minimum of 2 pixels per symbol pixel, the CMOS must be able to represent (2·8+4)·2 pixels horizontally and (18+4)·2 vertically, giving 40·44 pixels in all. More pixels mean more information in the image and the market conditions for CMOS sensors is limited for CMOS sensors with low numbers of pixels. The typical CMOS sensors available on the market have reduced resolution compared to the CCD sensor, which is used in applications as web cams, mobile telephones, and small digital cameras with resolutions less than 2 Mpix. Many of the smaller CMOS sensors available have a pixel resolution of 640×320 (VGA), 320×200 or QCIF 160×128 pixels, which is slightly more than necessary as compared to the present invention disclosed herein.

The image sensor may be the LM9630 from National Semiconductors. The number of pixels is 101×128, it has high light sensitivity and a maximum frame rate of 580 frames per second (Fps). The high frame rate is not necessary for this application, nor is the high light sensitivity.

Sampling of Image

In order to capture an image (from one or more code information elements), which can be reconstructed, the sampling period may have to be equal to or smaller than one-half of the period of the finest detail. The resolution of an image sensor must have a resolution high enough so that the image through the optical lens will have more than 2 samples per pixel, i.e. Nyquist criterion.

In an embodiment of the invention, the code information element is a DM, which has 8 symbols vertically and 18 horizontally (144 symbol pixels), which means that for the chosen image sensor, the lens could have an enlargement less than 101/8 or 128/18, which is about 7 times. Otherwise there may be a risk that the image cannot be reconstructed, i.e. the image is undersampled.

The DM image can theoretically be reconstructed if it has more than 16×36 pixels. A doubling of the pixels increase the calculation time, but also enhances the chance of obtaining a correct DM symbol, since there are more pixels to work with.

In order to identify which processes are needed in order to decode a DM, the nature of the captured images has to be analysed.

The lens used is mounted in a camera house, but the positioning of the lens could not be tested during the manual process of gluing, which resulted in lenses that did not have the optical axis in the centre of the image.

Labelling—Label

The code information element, e.g. the DM is printed in a white area on the label. Preferably the DM must be situated in the centre of the white area, and the white area must be so wide, that the white band (also in worst case conditions) is the background of the DM.

The best sharpness is gained when one symbol pixel of the DM is represented by 2 to 3 pixels. This may be true, but it is estimated that the algorithms work best if there is a more pixels to play with.

DM is a 2D matrix code invented by RVSI Acuity CiMatrix, a subsidiary of Robotic Vision Systems, Inc., and placed in the public domain. DM is designed for a high code density and employs RS error correction with data redundancy to ensure reliability. A DM symbol can store between one and 3116 numeric or 2335 alphanumeric characters. While DM is scalable between 1-mil square to a 14-inch square, the actual limits are dependent on the fidelity of the marking device and the optics of the reader.

Several other 2D codes or symbologies exist, apart from DM and as alternatives to DM, i.e. Data Matrix. Some alternatives are stacked codes, like PDF417, and some alternatives are matrix codes. Stacked codes can best be described as having two or more rows of one-dimensional barcodes and so also possess a direction—first row, second row, while matrix codes are non-directional. A non-comprehensive list of available matrix codes includes Data Glyphs, Aztech Code, Code 1, CP Code, MaxiCode, QR Code, Snowflake code and Ultacode.

Most widely used 2D codes contain indicia that ease the determination of size, position and angular orientation of the imaged code. The mentioned quantities are often required for extracting the information from the code. For example, Datamatrix codes have two solid perimeter lines that constitute an L shape. The L shape can easily be located by known machine vision algorithms, such as gradient or threshold based edge finder algorithms. Thereby the L shape allows determination of the mentioned quantities.

According to the invention, repeated information code elements may be applied on the container in various ways, such as mutually separated patterns, as a coherent pattern and/or as partly coherent patterns.

Additional information, such as non-repeated information, may be applied on the container in combination with the invention of applied repeated code information elements. The additional information can be coherent to the repeated code information elements.

Further, according to the invention, any of the repeated code information elements can be constituted by a first code information element containing a first set of information, combined with a second code information element containing a second set of information from which the first set of information can be extracted by means of a predetermined data transformation algorithm. The data transformation algorithm can for example be reducing the amount of information in the second set of information to fit the first set of information. Thereby, the first set of information is visible to the user or a reading system in both cases, i.e. the first set of information may be a result of applying either said first or said second code information element.

1. A container (10) for a medication delivery (110) device comprising an optical reader (111), where said container comprises a code information element (20) carrying a set of information readable by said optical reader wherein the container comprises at least one more code information element (20) carrying the set of information readable by said optical reader.

2. A container according to claim 1, wherein the information elements are aligned with at least one protrusion (15) on the container.

3. A container according to claim 1, wherein the code information elements are aligned with at least one cavity (16) on the container.

4. A container according to claim 1, wherein the code information elements are juxtaposed to one another.

5. A container according to claim 1, wherein the code information elements are applied on the surface of the container.

6. A container according to claim 1, wherein the information in each of the code information elements is laser engraved.

7. A container according to claim 1, wherein the code information element are printed on a label.

8. A container according to claim 7, wherein the label is integral with another label for carrying readable information.

9. A container according to claim 8, wherein another label is transparent.

10. A container according to claim 1, wherein each of said code information elements comprises pixels.

11. A container according to claim 1 wherein each of said code information element comprises a Data Matrix code.

12. A container according to claim 1 wherein each of said code information element comprises redundant data.

13. A container according to claim 1 wherein said set of information represents at least a medicament type.

14. A container according to claim 1, characterized in that said set of information further represents an expiry date.

15. A container according to claim 1, characterized in that said set of information further represents a batch number.

16. A container according to claim 1, characterized in that said set of information comprises a string of characters representing a manufacturer of the content.

17. A container according to claim 1, characterized in that said container comprises a further number of code information elements between 1 and 100.

18. A container according to claim 1, characterized that said container comprises a further number of code information elements between 2 and 20.

19. A container according to claim 1, characterized in that said container comprises a further number of code information elements between 3 and 30.

20. A container according to claim 1, characterized in that a surface of an information-carrying area of each of said code information elements is treated to enhance optical reading of said set of information.

21. A container according to claim 20, characterized in that the treatment comprises use of a transparent printing ink with dispersed transparent particles.

22. A container according to claims 21, characterized n that the size of each of said particles is approximately 5-10 times smaller than a size of pixels in each of the code information elements.

23. A container according to according to claim 1 characterized in that said container is a cartridge.

24. A container according to claim 23, characterized in that the label is wrapped around the container.

25. A container according to claim 23, characterized in that the distance between juxtaposed code information elements repeated around the container is dependent on the tolerance of the diameter of the container.

26. A container according to claim 25, characterized in that the juxtaposed code information elements are repeated all the way around the container.

27. A container according to claim 23, characterized in that the container comprises a plunger, and where said code information elements are applied directly opposite the plunger in its position of storage.

28. A container according to claims 23, characterized in that the axial position of the code information elements are defined relative to the end of the container comprising the plunger in its position of storage.

29. A container according to claim 23, characterized in that said code information elements are repeated a number of times around the container.

30. A container according to claim 23, characterized that said code information elements are repeated a number of times along the container.

31. A method of applying code information elements according to claim 1, characterized in that said code information elements are applied on an endless band arranged to be pushed over the container and where a part of said endless band then is applied on the container.

32. A method of reading a code information element according to claim 1, characterized in that an optical reader (111) is used whose field of vision is so comprehensive that it is able to accommodate significantly more than one single code information element (20).

33. A method according to claim 32, characterized in that an image sensor is used together with optics for presenting one single code information element (20) and at least one fraction of a neighbouring code information element (20) on the optical reader (111).

34. A method according to claims 32, characterized in that the image sensor is a CMOS type sensor.
